(19) United States
(12) Patent Application Publication
(10) Pub. No.: US 2019/0028396 A1
(43) Pub. Date: Jan. 24, 2019

(54) RELAY DEVICE, METHOD AND NON-TRANSITORY COMPUTER-READABLE STORAGE MEDIUM

(71) Applicant: FUJITSU LIMITED, Kawasaki-shi (JP)

(72) Inventors: Hideyo Fukunaga, Fukuoka (JP); Yoshihiko KOGA, Fukuoka (JP); Shinichi Fujiyoshi, Fukuoka (JP); Hiroaki KUBO, Fukuoka (JP); Tsuneharu Suzuki, Fukuoka (JP); Takashi Kato, Fukuoka (JP)

(73) Assignee: FUJITSU LIMITED, Kawasaki-shi (JP)

(21) Appl. No.: 16/031,297

(22) Filed: Jul. 10, 2018

(30) Foreign Application Priority Data
Jul. 19, 2017 (JP) 2017-139786

(51) Int. Cl. H04L 12/823; H04L 12/46; H04L 29/06; H04L 12/741

(52) U.S. Cl. CPC H04L 47/32; H04L 45/74; H04L 69/22; H04L 12/46

(57) ABSTRACT

A first relay device included in a plurality of relay devices each of which configured to forward a frame to another relay device, the first relay device includes a memory, and a processor coupled to the memory and configured to receive a frame which includes a count value which is reduced by another relay device according to forwarding by the another relay device, set a second value in the count value of the received frame, wherein the second value is specified in accordance to a destination device of the frame, and after setting the second value in the count value, transmit the frame to another relay device of the plurality of relay devices.

### CROSS-REFERENCE TO RELATED APPLICATION

This application is based upon and claims the benefit of priority of the prior Japanese Patent Application No. 2017-139786, filed on Jul. 19, 2017, the entire contents of which are incorporated herein by reference.

### FIELD

The embodiments discussed herein are related to a relay device, a method and a non-transitory computer-readable storage medium.

### BACKGROUND

The header of a frame of internet protocol version 4 (IPv4) or IP version 6 (IPv6) includes an 8-bit field in which the lifetime of the frame, called time to live (TTL), is specified.

One is subtracted from the value of the TTL each time a frame to which the TTL is set passes through a router. With the TTL, forwarding is allowed up to the maximum number of hops of 255. Discard processing is performed on a frame, the value of the TTL of which is zero, and a discard notification is transferred to a source from which the frame is transferred. Such control does not allow the frame to be forwarded in a loop within a network. A citation list includes Japanese Laid-open Patent Publication No. 2-109445, and Japanese Laid-open Patent Publication No. 2003-298629.

### SUMMARY

According to an aspect of the invention, a first relay device included in a plurality of relay devices each of which configured to forward a frame to another relay device, the first relay device includes a memory, and a processor coupled to the memory and configured to receive a frame which includes a count value which is reduced by another relay device according to forwarding by the another relay device, set a second value in the count value of the received frame, wherein the second value is specified in accordance to a destination device of the frame, and after setting the second value in the count value, transmit the frame to another relay device of the plurality of relay devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration a forwarding control device.

FIG. 2 is a diagram illustrating an exemplary configuration a communication network.

FIG. 3 is a diagram illustrating an exemplary hardware configuration of a router bridge.

FIG. 4 is a diagram illustrating an exemplary functional block of the router bridge.

FIG. 5 is a diagram illustrating the format of a TRILL frame.

FIG. 6 is a diagram illustrating exemplary frame forwarding through a TRILL network.

FIG. 7 is a diagram illustrating exemplary table management.

FIG. 8 is a diagram illustrating an exemplary configuration of a communication network.

FIG. 9 is a diagram for description of a rewrite operation of a hop count value.

FIG. 10 is a diagram for description of the rewrite operation of the hop count value.

FIG. 11 is a diagram illustrating exemplary table management.

FIG. 12 is a diagram illustrating part of a frame forwarding path.

FIG. 13 is a diagram for description of operation of performing FCS comparison to detect loop reception.

FIG. 14 is a flowchart illustrating operation of the router bridge.

### DESCRIPTION OF EMBODIMENTS

Ethernet Fabric (Ethernet is a registered trademark; same in the following), which is suitable for virtualization environment, has been increasingly introduced along with progress in the technology of virtualization of data centers and networks. Ethernet Fabric implements functions based on, for example, Transparent Interconnection of Lots of Links (TRILL) standardized by the Internet Engineering Task Force (IETF).

The TRILL achieves redundant configuration control and load balance. To avoid occurrence of a loop state, a TRILL frame includes a hop count field that allows specification of the lifetime of the frame.

However, in the TRILL, the field of a hop count value is defined to be in six bits, and thus forwarding is allowed only up to the maximum number of hops of 63, and any frame, the number of hops of which exceeds 64, is discarded. This limitation by the hop count value leads to inefficient frame forwarding that does not allow a frame to be forwarded in 64 hops or more.

The present embodiments will be described below with reference to the accompanying drawings.

### First Embodiment

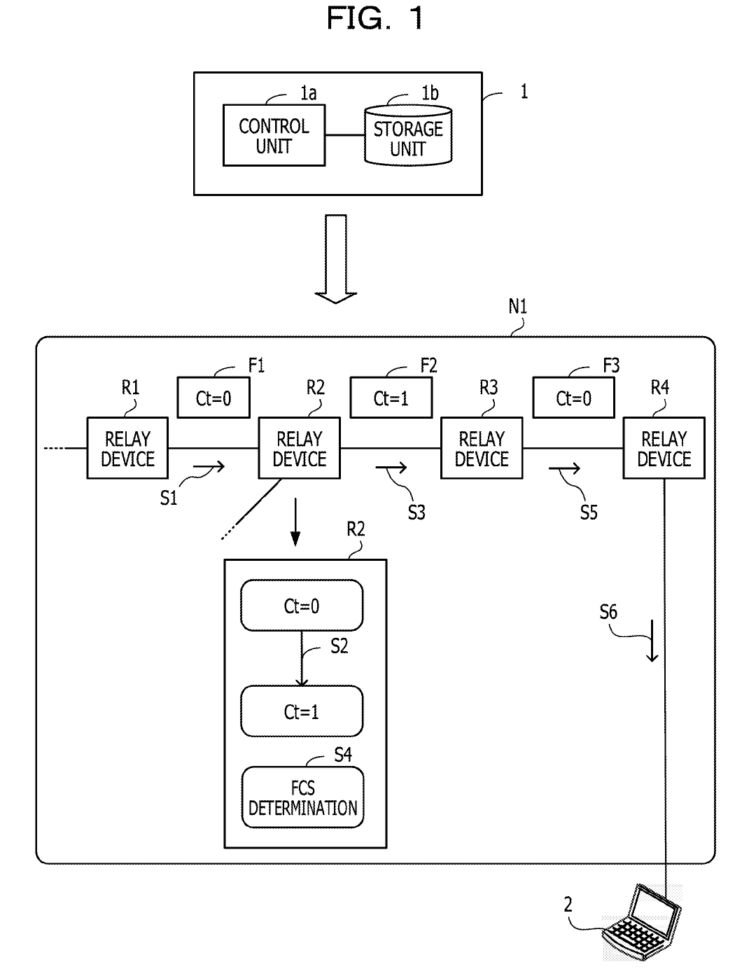

The following describes a forwarding control device according to a first embodiment with reference to FIG. 1. FIG. 1 is a diagram illustrating an exemplary configuration of the forwarding control device. This forwarding control device 1 includes a control unit 1a and a storage unit 1b. When performing forwarding control of a frame including a count value subtracted in accordance with relay forwarding, the control unit 1a specifies a predetermined count value in accordance with the destination of a received frame.

The control unit 1a sets the count value of a transmission frame that is transmitted at relay forwarding of the received frame to be the specified predetermined count value, and forwards the transmission frame including the predetermined count value. The storage unit 1b stores the predetermined count value and other control information.

The following describes operation of the control unit 1a with the example illustrated in FIG. 1. A network N1 includes relay devices R1, . . . , and R4, and the relay device R4 is coupled with a terminal 2 as a destination device. The relay devices R1, . . . , and R4 each have functionality of the forwarding control device 1. A frame relayed and forwarded by the relay devices R1, . . . , and R4 includes an integer count value from which one is subtracted at each relay.

[Step S1] The relay device R1 receives a frame relayed in the network N1, subtracts one from a count value Ct set to the received frame, and transmits the frame to the relay device R2.

For example, the count value Ct becomes zero through the subtraction at the relay device R1, and a frame F1 having the count value Ct set to be zero is transmitted from the relay device R1.

[Step S2] The relay device R2 receives the frame F1 having the count value Ct set to be zero. In this case, when the frame reaches the relay device R4 belonging to the terminal 2 as the destination device, the relay device R2 specifies the count value Ct so that the count value Ct included in the frame becomes equal to a predetermined value, for example, zero. In this example, the count value Ct (predetermined count value) is specified and rewritten to be one.

[Step S3] The relay device R2 transmits, to the relay device R3, a frame F2 having the count value Ct rewritten to be one.

[Step S4] The relay device R2 calculates and stores, for example, a frame check sequence (FCS) as error detection data of the frame having the rewritten count value Ct. Upon reception of the frame, the relay device R2 compares the FCS of the received frame with the stored FCS. When the FCSs match with each other, the relay device R2 determines that the received frame is a frame returned in a loop (loop reception), and discards the frame.

[Step S5] The relay device R3 subtracts one from the count value Ct of the received frame F2. The count value Ct becomes zero at the relay device R3. Then, the relay device R3 transmits, to the relay device R4, a frame F3 having the count value Ct set to be zero.

[Step S6] The relay device R4 receives the frame F3 having the count value Ct set to be zero, but the relay device R4 belongs to the terminal 2 as the destination device. Thus, the relay device R4 transmits the frame F3 to the terminal 2.

As described above, when the frame F1 having the count value Ct set to be zero is received by the relay device R2, the relay device R2 rewrites the count value Ct to be one and transmits the frame. Accordingly, when the frame is forwarded through the relay devices R3 and R4, the count value Ct becomes equal to zero through subtraction of one at the relay device R3, and the frame is relayed to the relay device R4 and transmitted to the terminal 2 from the relay device R4 belonging to the terminal 2.

In this manner, when having received a frame having the count value set to be zero, a relay device not belonging to the destination device rewrites the count value so that the frame is transmitted to the destination device. Accordingly, it is possible to perform frame forwarding without limitation by the count value.

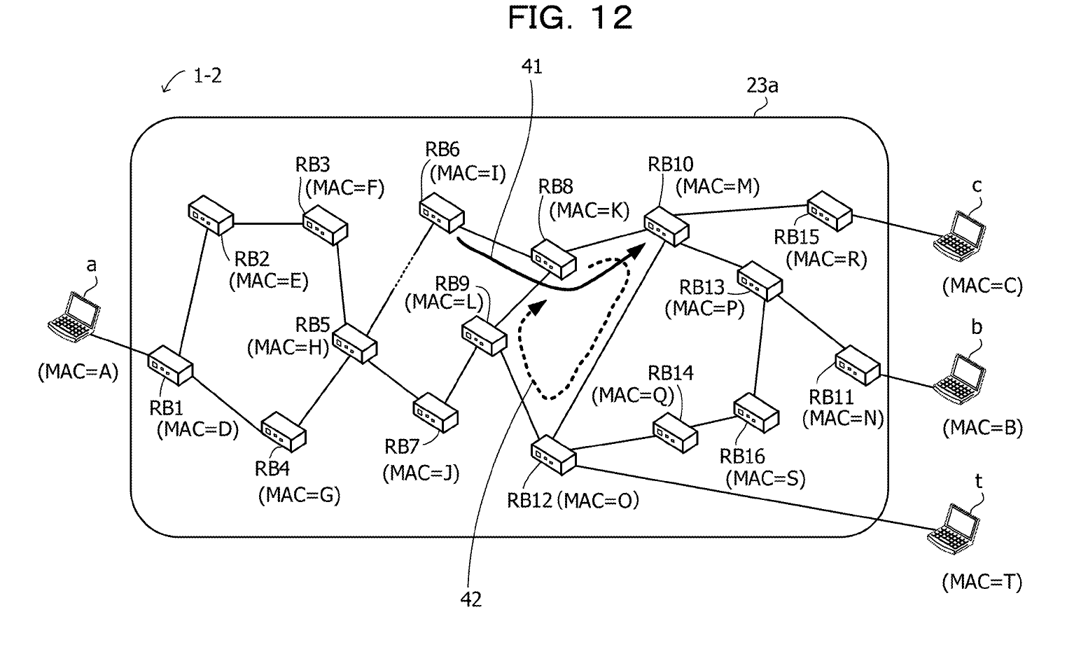

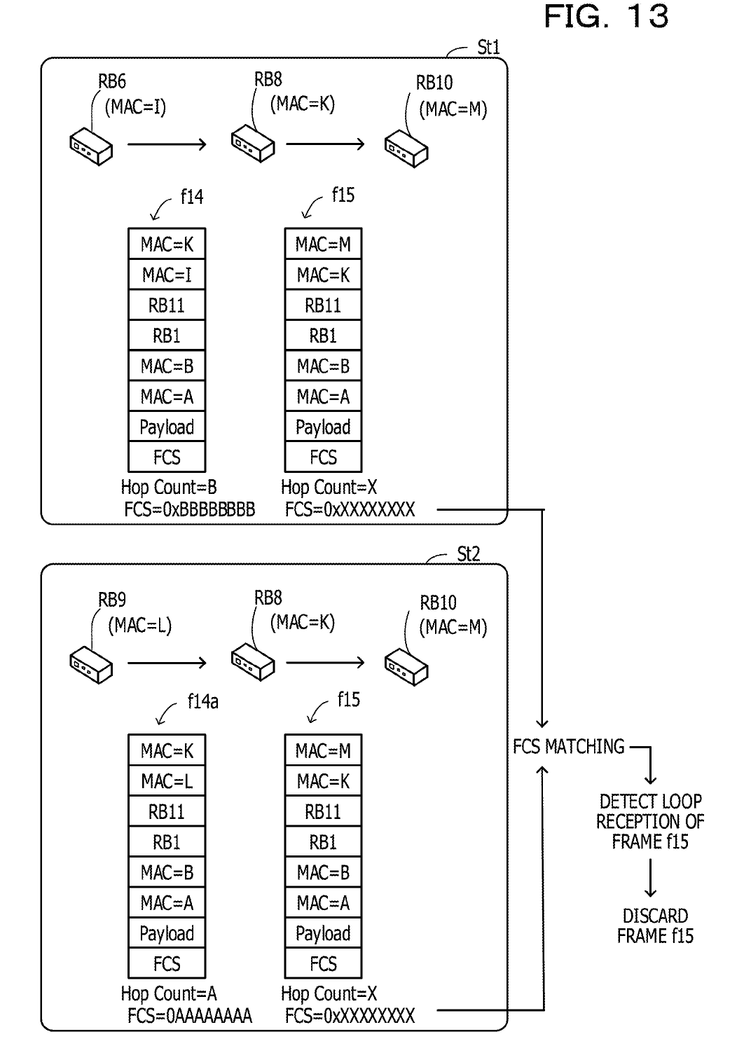

A frame is potentially forwarded in a loop due to rewriting of the count value. To avoid this, as described above, a relay device having rewritten the count value performs detection of the loop reception based on the FCS after the rewriting of the count value. When having detected the loop reception, the relay device discards the frame. Accordingly, it is possible to avoid the loop reception (to be described later with reference to FIGS. 12 and 13).

### Second Embodiment

The following describes a second embodiment. In the second embodiment, any function according to the present disclosure is applied to a TRILL network. The following description will be first made on a network configuration.

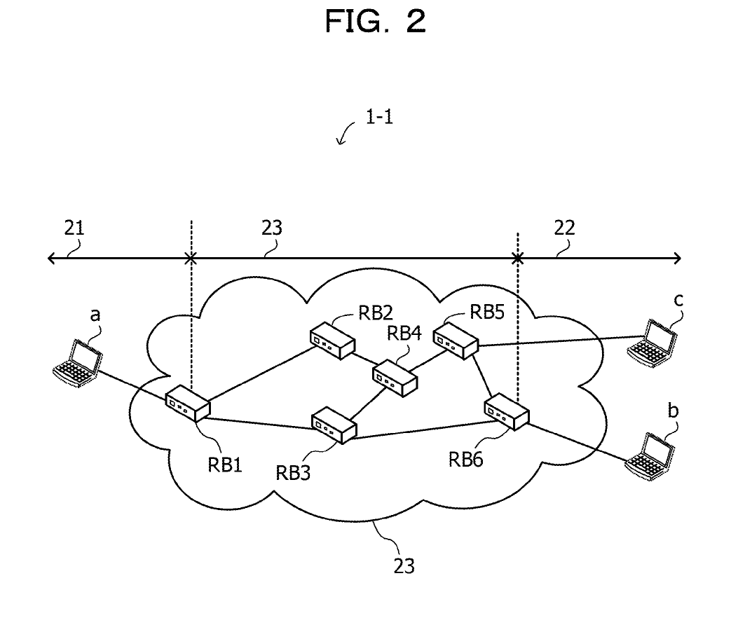

FIG. 2 is a diagram illustrating an exemplary configuration of a communication network. This communication network 1-1 includes Ethernets 21 and 22 and a TRILL network 23.

The Ethernet 21 includes a terminal a, and the Ethernet 22 includes terminals b and c. The TRILL network 23 includes router bridges RB1, . . . , and RB6 each having a Layer 2 (or Layer 3) switch function.

The coupling relation between instruments is as follows. The terminal a is coupled with the router bridge RB1. The router bridge RB1 is also coupled with the router bridges RB2 and RB3. The router bridge RB4 is coupled with the router bridges RB2, RB3, and RB5. The router bridge RB6 is coupled with the router bridges RB3 and RB5 and the terminal b. The terminal c is coupled with the router bridge RB5.

<Hardware of Router Bridge>

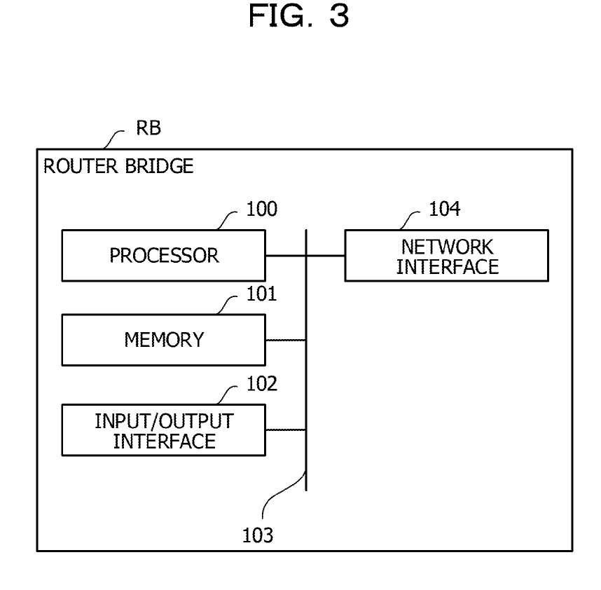

FIG. 3 is a diagram illustrating an exemplary hardware configuration of a router bridge. This router bridge RB is entirely controlled by a processor 100. In other words, the processor 100 functions as a control unit of the router bridge RB.

The processor 100 is coupled with a memory 101 and a plurality of peripheral instruments through a bus 103. The processor 100 may be a multiprocessor. The processor 100 is, for example, a central processing unit (CPU), a micro processing unit (MPU), a digital signal processor (DSP), an application specific integrated circuit (ASIC), or a programmable logic device (PLD). Alternatively, the processor 100 may be a combination of two elements or more of a CPU, an MPU, a DSP, an ASIC, and a PLD.

The memory 101 is used as a main storage device of the router bridge RB. The memory 101 temporarily stores at least part of an operating system (OS) program and any application program to be executed by the processor 100. The memory 101 also stores various kinds of data used in processing by the processor 100.

The memory 101 is also used as an auxiliary storage device of the router bridge RB to store an OS program, any application program, and various kinds of data. The memory 101 may include, as the auxiliary storage device, a semiconductor storage device such as a flash memory or a solid state drive (SSD), or a magnetic recording medium such as a hard disk drive (HDD).

Examples of the peripheral instruments coupled with the bus 103 include an input/output interface 102 and a network interface 104. The input/output interface 102 is coupled with a monitor (for example, a light emitting diode (LED) display or a liquid crystal display (LCD)) that functions as a display device configured to display the state of the router bridge RB in response to a command from the processor 100.

The input/output interface 102 may be coupled with an information input device such as a keyboard or a mouse, and configured to transmit, to the processor 100, a signal transferred from the information input device.

The input/output interface 102 also functions as a communication interface for coupling with a peripheral instrument. For example, the input/output interface 102 may be coupled with an optical drive device configured to read, by using laser light or the like, data recorded on an optical disk. The optical disk is a portable recording medium recording data readable by light reflection. Examples of the optical disk include a digital versatile disc (DVD), a DVD random access memory (DVD-RAM), a compact disc read-only memory (CD-ROM), a CD-R (recordable), and a CD-RW (rewritable).

The input/output interface 102 may be also coupled with a memory device or a memory reader or writer. The memory device is a recording medium having a function to achieve communication with the input/output interface 102. The memory reader or writer is a device configured to read or write data from or to a memory card. The memory card is a recording medium in a card shape.

The network interface 104 controls interface with a network and may be achieved by, for example, a network interface card (NIC) or a wireless local area network (LAN) card. Data received by the network interface 104 is output to the memory 101 and the processor 100.

Processing functions of the router bridge RB are achieved by the hardware configuration as described above. For example, the router bridge RB performs control according to the present disclosure through the processor 100 executing a predetermined computer program.

The router bridge RB achieves the processing functions according to the present disclosure by, for example, executing a computer program recorded in a computer-readable recording medium. Computer programs that describe the contents of processing executed by the router bridge RB may be recorded in various recording media.

For example, a computer program to be executed by the router bridge RB may be stored in the auxiliary storage device. The processor 100 loads at least part of the computer program in the auxiliary storage device onto the main storage device, and executes the computer program.

The computer program may be recorded in a portable recording medium such as an optical disk, a memory device, or a memory card. For example, the computer program stored in such a portable recording medium becomes executable once installed on the auxiliary storage device under control of the processor 100. The processor 100 may read the computer program directly from the portable recording medium and execute the computer program.

<Functional Block of Router Bridge>

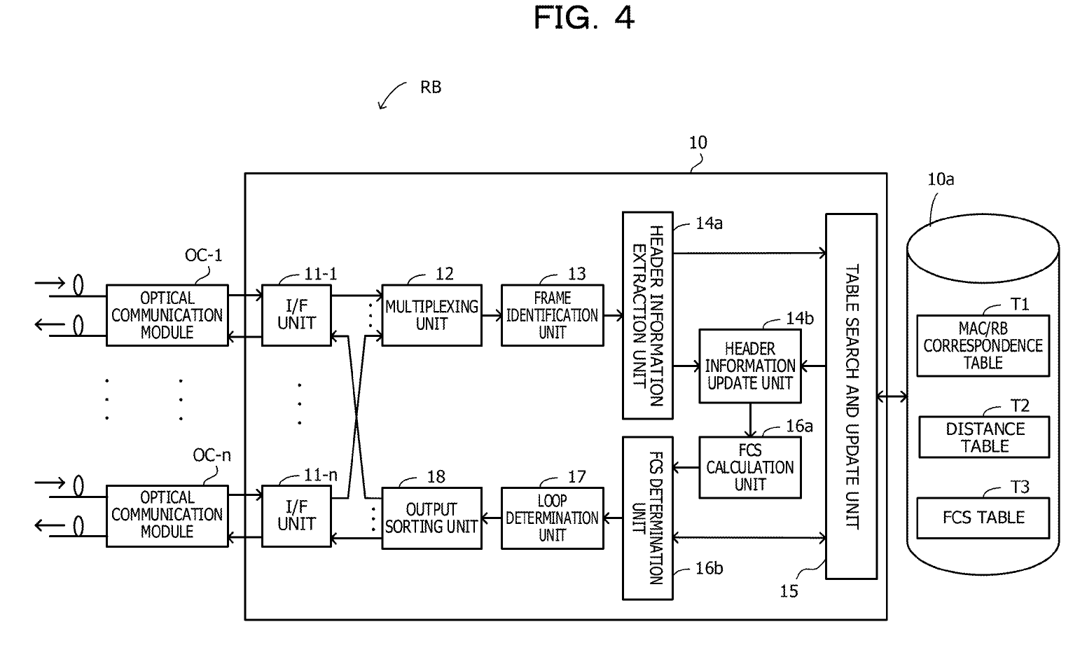

FIG. 4 is a diagram illustrating an exemplary functional block of the router bridge. The router bridge RB includes optical communication modules OC-1, . . . , and OC-n, a frame forwarding control unit 10, and a table management unit 10a.

The frame forwarding control unit 10 includes interface (I/F) units 11-1, . . . , and 11-n, a multiplexing unit 12, a frame identification unit 13, a header information extraction unit 14a, a header information update unit 14b, a table search and update unit 15, a FCS calculation unit 16a, a FCS determination unit 16b, a loop determination unit 17, and an output sorting unit 18. The table management unit 10a includes a MAC/RB correspondence table T1, a distance table T2, and a FCS table T3.

When having received an optical frame transmitted from an adjacent router bridge RB or terminal through an optical line, the optical communication modules OC-1, . . . , and OC-n each generate an electric frame through optical/electric (O/E) conversion, and output the electric frame to the corresponding one of the I/F units 11-1, . . . , and 11-n.

When having received an electric frame transmitted from each of the I/F units 11-1, . . . , and 11-n, the corresponding one of the optical communication modules OC-1, . . . , and OC-n generates an optical frame through E/O conversion, and outputs the optical frame to an adjacent router bridge RB or terminal through an optical line.

The I/F units 11-1, . . . , and 11-n perform interface control related to Ethernet Layers 1 and 2, such as frame buffering, modulation and demodulation processing, and frame analysis based on a media access control (MAC) address.

The multiplexing unit 12 multiplexes a frame received through a line coupled with the multiplexing unit 12. The frame identification unit 13 identifies a coupling destination of the multiplexed frame. The header information extraction unit 14a extracts header information from each frame subjected to the identification.

The header information update unit 14b updates header information based on destination and distance information transmitted from the table search and update unit 15 and header information extracted by the header information extraction unit 14a.

The table search and update unit 15 searches and updates contents registered to the MAC/RB correspondence table T1, the distance table T2, and the FCS table T3, which are stored and managed by the table management unit 10a.

The FCS calculation unit 16a performs FCS calculation based on the updated header information. The FCS determination unit 16b compares the FCS of a received frame with a stored FCS. When the FCSs match with each other, the loop determination unit 17 determines that the received frame is a frame forwarded in a loop, and discards the frame. When having received a frame not forwarded in a loop, the output sorting unit 18 performs sorting by outputting the frame to an I/F unit coupled with a destination.

The frame forwarding control unit 10 is achieved by the processor 100 illustrated in FIG. 3, and the table management unit 10a is achieved by the memory 101 illustrated in FIG. 3. Each component may be achieved by a hardware circuit such as a logic circuit. The frame forwarding control unit 10 has the function of the control unit 1a illustrated in FIG. 1, and the table management unit 10a has the function of the storage unit 1b illustrated in FIG. 1.

<Format of TRILL Frame>

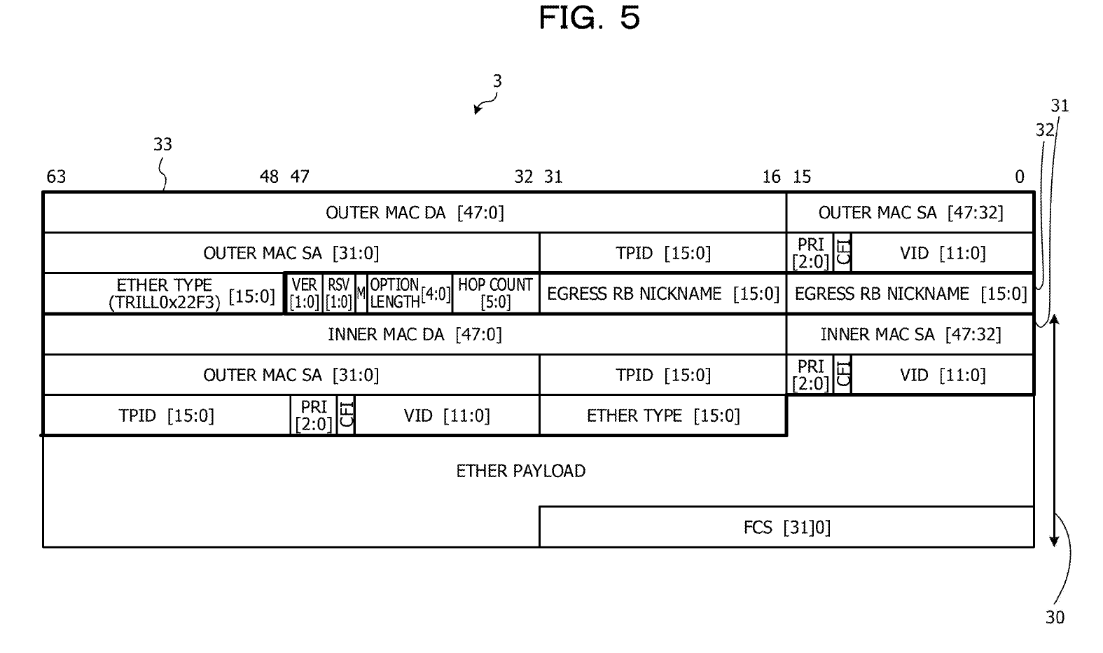

FIG. 5 is a diagram illustrating the format of a TRILL frame. This TRILL frame 3 includes a header and a payload, and a 4-byte FCS is appended to the payload. The header includes an inner MAC header 31, a TRILL header 32, and an outer MAC header 33.

The inner MAC header 31 is included in an Ethernet frame 30 transmitted from a source. When the Ethernet frame 30 is input to a TRILL network, the router bridge RB in the TRILL network adds the TRILL header 32 to the Ethernet frame 30 and performs encapsulation thereof.

The router bridge RB also adds the outer MAC header 33 for routing in the TRILL network. The contents of an outer MAC source address (SA) and an outer MAC destination address (DA) in the outer MAC header 33 are rewritten at passing through each router bridge RB.

In the inner MAC header 31, the inner MAC SA is set to be the MAC address of a source terminal of the frame, and the inner MAC DA is set to be the MAC address of a destination terminal of the frame.

In the TRILL header 32, an ingress RB nickname is set to be the identifier of an ingress router bridge RB of the TRILL network, and an egress RB nickname is set to be the identifier of an egress router bridge RB. The TRILL header 32 also includes a 6-bit Hop Count field.

In the outer MAC header 33, the outer MAC SA is set to be a source MAC address of the router bridge RB, and the outer MAC DA is set to be a destination MAC address of the router bridge RB.

<Exemplary Frame Forwarding>

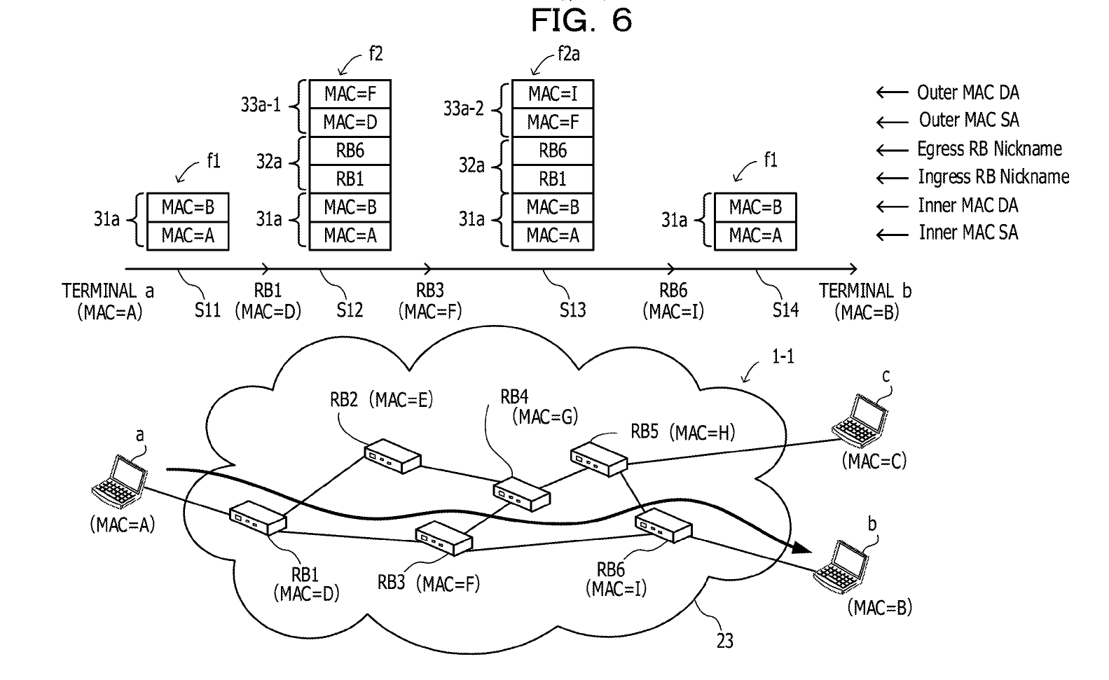

FIG. 6 is a diagram illustrating exemplary frame forwarding through a TRILL network. When forwarded from the terminal a to the terminal b in the communication network 1-1 illustrated in FIG. 2, a frame passes through the router bridges RB1, RB3, and RB6 (the ingress router bridge is the router bridge RB1, and the egress router bridge is the router bridge RB6).

Consider a case in which the terminals a, b, and c have MAC addresses A, B, and C, respectively, and the router bridges RB1, RB2, RB3, RB4, RB5, and RB6 have MAC addresses D, E, F, G, H, and I, respectively.

[Step S11] the terminal a sets the MAC address “A” to the inner MAC SA and the MAC address “B” to the inner MAC DA in an inner MAC header 31a, generates a frame f1, and transmits the frame f1 to the router bridge RB1.

[Step S12] The router bridge RB1 receives the frame f1. The router bridge RB1 adds, to the frame f1, a TRILL header 32a having the ingress RB nickname set to be the identifier “RB1” of the router bridge RB1 and the egress RB nickname set to be the identifier “RB6” of the router bridge RB6.

The router bridge RB1 also adds, to the frame f1, an outer MAC header 33a-1 having the outer MAC SA set to be the MAC address “D” of the router bridge RB1 and the outer MAC DA set to be the MAC address “F” of the router bridge RB3.

Then, the router bridge RB1 generates a frame f2 by adding the TRILL header 32a and the outer MAC header 33a-1 to the frame f1, and transmits the frame f2 to the router bridge RB3.

[Step S13] The router bridge RB3 receives the frame f2. The router bridge RB3 rewrites the outer MAC SA in the outer MAC header 33a-1 from the MAC address “D” of the router bridge RB1 to the MAC address “F” of the router bridge RB3.

The router bridge RB3 also rewrites the outer MAC DA in the outer MAC header 33a-1 from the MAC address “F” of the router bridge RB3 to the MAC address “I” of the router bridge RB6.

Then, the router bridge RB3 generates a frame f2a to which an outer MAC header 33a-2 obtained through the MAC address rewriting is added, and transmits the frame f2a to the router bridge RB6.

[Step S14] The router bridge RB6 receives the frame f2a. The router bridge RB6 generates the frame f1 by deleting the outer MAC header 33a-2 and the TRILL header 32a from the frame f2a, and transmits the frame f1 to the terminal b.

<Table Management>

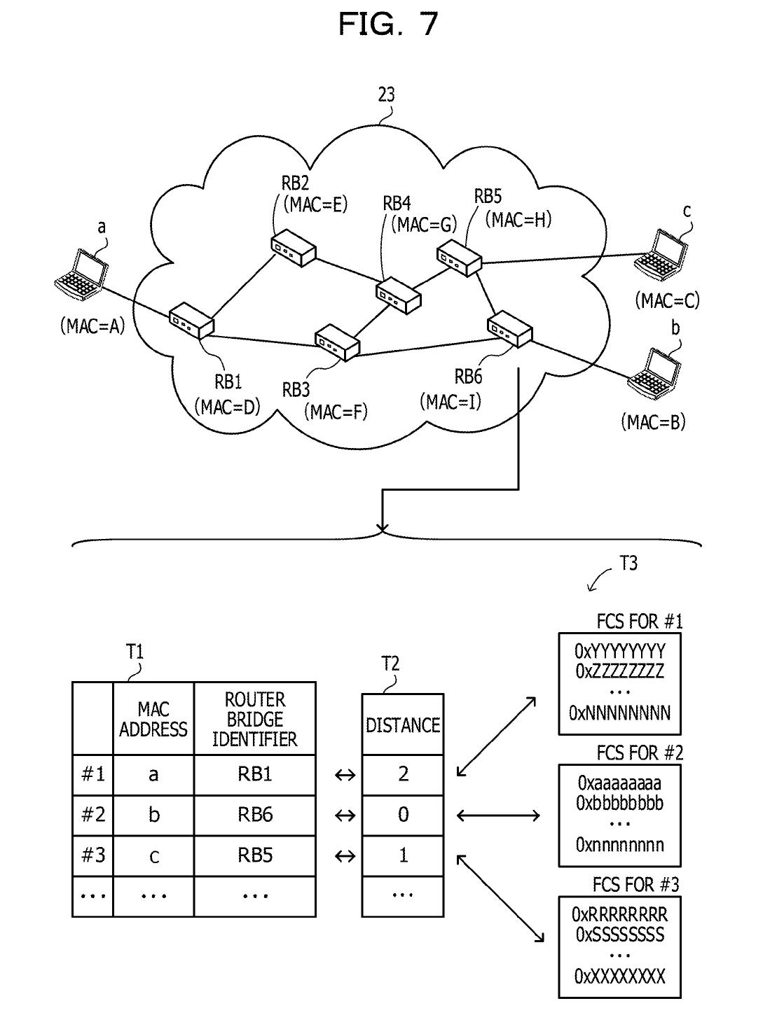

FIG. 7 is a diagram illustrating exemplary table management. At each router bridge RB, the table management unit 10a illustrated in FIG. 4 manages the MAC/RB correspondence table T1, the distance table T2, and the FCS table T3. FIG. 7 illustrates an example with a table management state of the router bridge RB6 in the frame forwarding described above with reference to FIG. 6.

The MAC/RB correspondence table T1 registers a correspondence relation between the MAC address of a terminal coupled with the TRILL network and the identifier of an ingress or egress router bridge RB coupled with the terminal.

The MAC/RB correspondence table T1 is used to recognize which router bridge RB is coupled with the terminal. The MAC/RB correspondence table T1 is generated by MAC learning based on the inner MAC SA (source address information) and the ingress RB nickname (identification information of a relay device) of a forwarded frame.

In the example illustrated in FIG. 7, since the terminal a is coupled with the router bridge RB1, the MAC address “A” and the router bridge identifier “RB1” are associated with each other. Since the terminal b is coupled with the router bridge RB6, the MAC address “B” and the router bridge identifier “RB6” are associated with each other. Since the terminal c is coupled with the router bridge RB5, the MAC address “C” and the router bridge identifier “RB5” are associated with each other.

The distance table T2 manages the distance (the number of hops) between a router bridge RB and a terminal. The router bridge RB calculates the number of hops to a terminal from which a received frame is transmitted based on a hop count value set to the frame, and registers the number of hops to the distance table T2. The distance is also calculated by subtracting, from 64 (maximum count value), a value set to the Hop Count field in the TRILL header 32 of the received frame.

In the example illustrated in FIG. 7, a frame transmitted from the terminal a to the router bridge RB6 passes through the router bridges RB1. and RB3 (shortest route), and thus has a hop count value of 62 when arrived at the router bridge RB6. Accordingly, the router bridge RB6 calculates the distance to the terminal a to be two (=64−62).

A frame transmitted from the terminal b is directly transmitted to the router bridge RB6, and thus the router bridge RB6 calculates the distance to the terminal b to be zero (=64−64).

A frame transmitted from the terminal c passes through the router bridge RB5 (shortest route), and thus has a hop count value of 63 when arrived at the router bridge RB6. Accordingly, the router bridge RB6 calculates the distance to the terminal c to be one (=64−63). Distances calculated in this manner are registered and managed in the distance table T2.

The FCS table T3 manages a calculation result of the FCS of a frame after the hop count value rewriting. The FCS table T3 is used to detect the loop reception of a frame after the hop count value rewriting.

The MAC/RB correspondence table T1, the distance table T2, and the FCS table T3 manage the MAC addresses, the identifiers of the router bridges RB, the distances, and the FCSs in association with each other.

The number of FCSs registered to the FCS table T3 in association with the MAC addresses and the identifiers of the router bridges RB are calculated at least for the latencies of the router bridges RB.

<Rewriting of Hop Count Value>

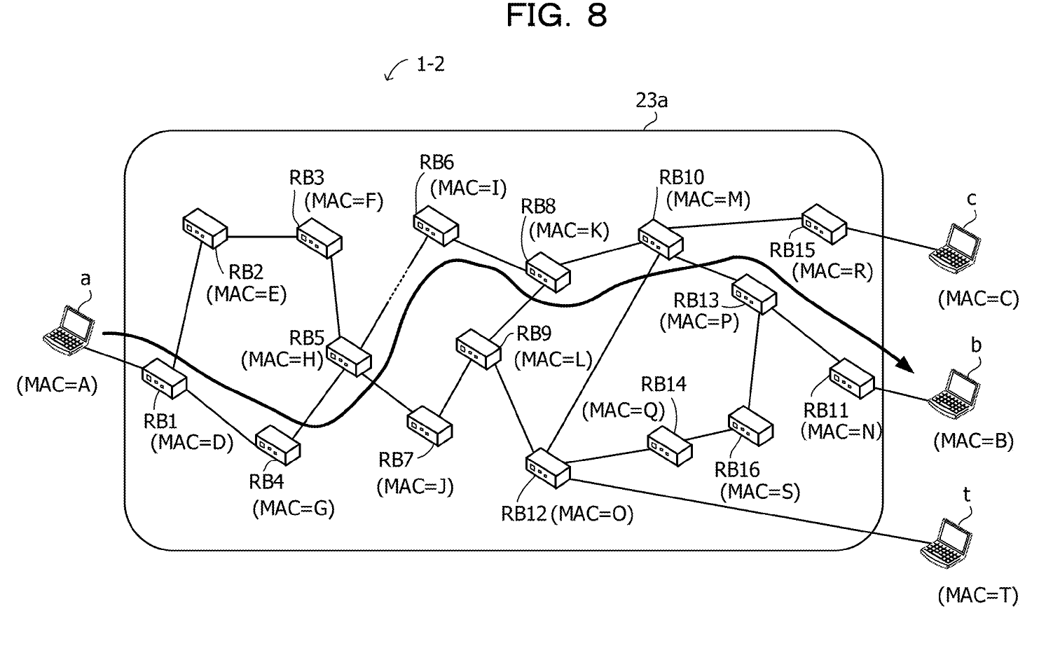

The following describes operation of rewriting a hop count value with reference to FIGS. 8, 9, and 10. FIG. 8 is a diagram illustrating an exemplary configuration of the communication network. This communication network 1-2 includes a TRILL network 23a coupled with terminals a, b, c, and t.

The TRILL network 23a includes router bridges RB1, . . . , and RB16. The coupling relation between instruments is as follows. The terminal a is coupled with the router bridge RB1. The router bridge RB1 is coupled with the router bridges RB2 and RB4, and the router bridge RB2 is also coupled with the router bridge RB3.

The router bridge RB5 is coupled with the router bridges RB3, RB4, and RB7. The router bridge RB5 is also coupled with the router bridge RB6 through a plurality of router bridges RB (not illustrated). The router bridge RB8 is coupled with the router bridges RB6, RB9, and RB10, and the router bridge RB9 is also coupled with the router bridges RB7 and RB12.

The router bridge RB10 is coupled with the router bridges RB12, RB13, and RB15. The router bridge RB14 is coupled with the router bridges RB12 and RB16, and the router bridge RB16 is also coupled with the router bridge RB13. The router bridge RB11 is coupled with the router bridge RB13 and the terminal b. The terminal c is coupled with the router bridge RB15, and the terminal t is coupled with the router bridge RB12.

The terminals a, b, c, and t have Mac addresses A, B, C, and T. When the MAC address of the router bridge RB* is referred to as (RB*: MAC=*), the router bridges RB1, . . . , and RB16 have MACS addresses as follows.

(RB1: MAC=D), (RB2: MAC=E), (RB3: MAC=F), (RB4: MAC=G), (RB5: MAC=H), (RB6: MAC=I), (RB7: MAC=J), (RB8: MAC=K), (RB9: MAC=L), (RB10: MAC=M), (RB11: MAC=N), (RB12: MAC=0), (RB13: MAC=P), (RB14: MAC=Q), (RB15: MAC=R), (RB16: MAC=S)

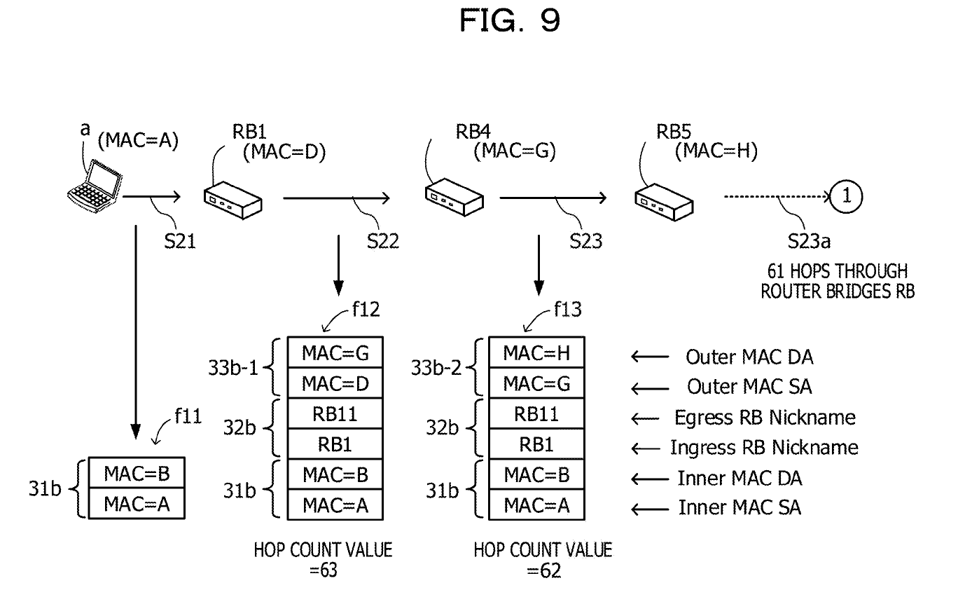

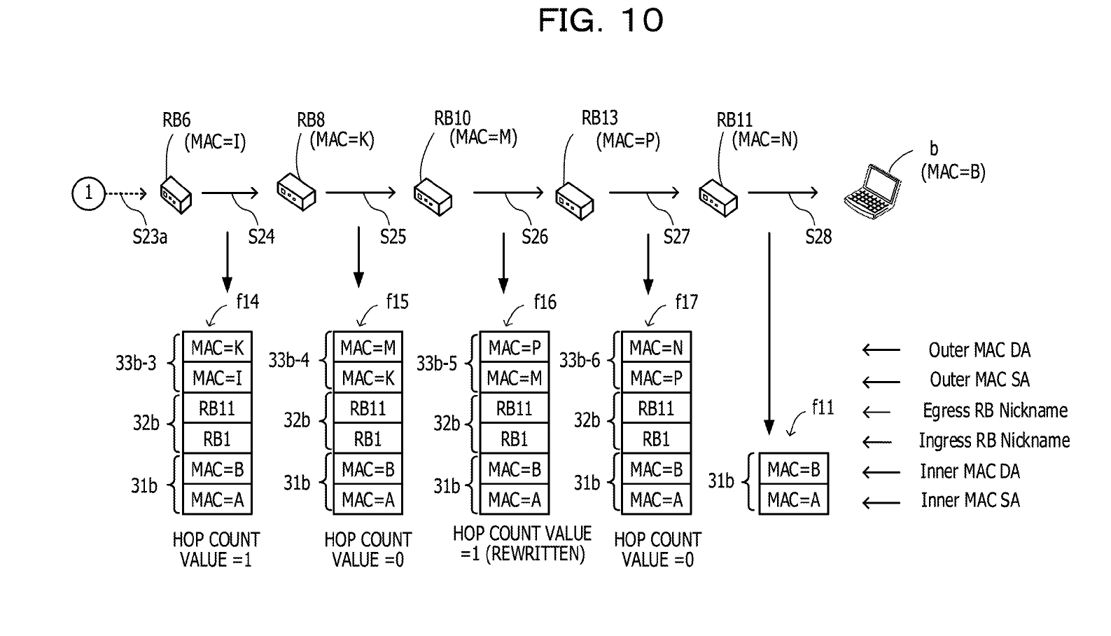

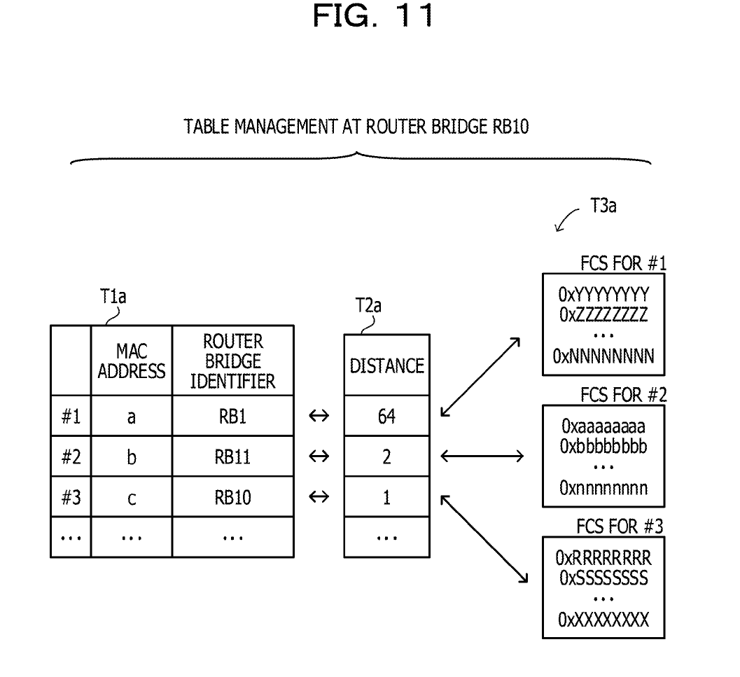

FIGS. 9 and 10 are each a diagram for description of the operation of rewriting a hop count value. FIG. 11 is a diagram of exemplary table management, illustrating a management state of a MAC/RB correspondence table T1a, a distance table T2a, and a FCS table T3a at the router bridge RB10.

For example, a frame is forwarded from the terminal a to the terminal b in the communication network 1-2, and relayed to the router bridges RB1, RB4, RB5, RB6, RB8, RB10, RB13, and RB11 in this order in the TRILL network 23a. In this configuration, the ingress router bridge is the router bridge RB1, and the egress router bridge is the router bridge RB11.

[Step S21] The terminal a sets the MAC address “A” to the inner MAC SA and the MAC address “B” to the inner MAC DA in an inner MAC header 31b, generates a frame f11, and transmits the frame f11 to the router bridge RB1.

[Step S22] The router bridge RB1 receives the frame f11. The router bridge RB1 adds, to the frame f11, a TRILL header 32b having the ingress RB nickname set to be the identifier “RB1” of the router bridge RB1 and the egress RB nickname set to be the identifier “RB11” of the router bridge RB11.

The router bridge RB1 also adds, to the frame f11, an outer MAC header 33b-1 having the outer MAC SA set to be the MAC address “D” of the router bridge RB1 and the outer MAC DA set to be the MAC address “G” of the router bridge RB4.

Then, the router bridge RB1 generates a frame f12 by adding the TRILL header 32b and the outer MAC header 33b-1 to the frame f11, and transmits the frame f12 to the router bridge RB4. The frame f12 has a hop count value set to be 63.

[Step S23] The router bridge RB4 receives the frame f12. The router bridge RB4 rewrites the outer MAC SA in the outer MAC header 33b-1 from the MAC address “D” of the router bridge RB1 to the MAC address “G” of the router bridge RB4.

The router bridge RB4 also rewrites the outer MAC DA in the outer MAC header 33b-1 from the MAC address “G” of the router bridge RB4 to the MAC address “H” of the router bridge RB5.

Then, the router bridge RB4 generates a frame f13 to which an outer MAC header 33b-2 obtained through the MAC address rewriting is added, and transmits the frame f13 to the router bridge RB5. The frame f13 has a hop count value set to be 62.

[Step S23a] The router bridge RB5 receives the frame f13. The router bridge RB5 rewrites the outer MAC SA in the outer MAC header 33b-2 to the MAC address “H” of the router bridge RB5, rewrites the outer MAC DA to the MAC address of the destination router bridge RB, and transmits the frame. In this example, the frame output from the router bridge RB5 passes 61 router bridges RB.

[Step S24] Having received the frame thus forwarded, the router bridge RB6 sets the MAC address “I” of the router bridge RB6 to the outer MAC SA, and sets the MAC address “K” of the router bridge RB8 to the outer MAC DA.

Then, the router bridge RB6 generates a frame f14 to which an outer MAC header 33b-3 obtained through the MAC address rewriting is added, and transmits the frame f14 to the router bridge RB8. The frame f14 has a hop count value set to be one.

[Step S25] The router bridge RB8 receives the frame f14. The router bridge RB8 rewrites the outer MAC SA in the outer MAC header 33b-3 from the MAC address “I” of the router bridge RB6 to the MAC address “K” of the router bridge RB8.

The router bridge RB8 also rewrites the outer MAC DA in the outer MAC header 33b-3 from the MAC address “K” of the router bridge RB8 to the MAC address “M” of the router bridge RB10.

Then, the router bridge RB8 generates a frame f15 to which an outer MAC header 33b-4 obtained through the MAC address rewriting is added, and transmits the frame f15 to the router bridge RB10. The frame f15 has a hop count value set to be zero.

[Step S26] The router bridge RB10 receives the frame f15. Since the hop count value of the frame f15 is zero, the router bridge RB10 rewrites the hop count value.

In this example, the tables managed at the router bridge RB10 illustrated in FIG. 11 are referred to. The router bridge RB10 detects, from the MAC/RB correspondence table T1a, that the terminal b belongs to the router bridge RB11. The router bridge RB10 also detects, from the distance table T2a, that the distance to the terminal b is two, and the terminal b is located ahead of the router bridge RB10 by two. Thus, the router bridge RB10 rewrites the hop count value to one (=2−1=(distance−1)).

The router bridge RB10 also rewrites the outer MAC SA in the outer MAC header 33b-4 to the MAC address “M” of the router bridge RB10. In addition, the router bridge RB10 rewrites the outer MAC DA in the outer MAC header 33b-4 to the MAC address “P” of the router bridge RB13.

Then, the router bridge RB10 generates a frame f16 to which an outer MAC header 33b-5 obtained through the MAC address rewriting is added, and transmits the frame f16 to the router bridge RB13. The frame f16 has a hop count value set to be one, which is the rewritten value.

[Step S27] The router bridge RB13 receives the frame f16. The router bridge RB13 rewrites the outer MAC SA in the outer MAC header 33b-5 to the MAC address “P” of the router bridge RB13. The router bridge RB13 also rewrites the outer MAC DA in the outer MAC header 33b-5 to the MAC address “N” of the router bridge RB11.

Then, the router bridge RB13 generates a frame f17 to which an outer MAC header 33b-6 obtained through the MAC address rewriting is added, and transmits the frame f17 to the router bridge RB11. The frame f17 has a hop count value set to be zero.

[Step S28] The router bridge RB11 receives the frame f17. The hop count value of the frame f17 is zero, and the router bridge RB11 belongs to the terminal b. Thus, the router bridge RB11 generates the frame f11 by deleting the outer MAC header 33b-6 and the TRILL header 32b from the frame f17, and transmits the frame f11 to the terminal b.

<Loop Reception Detection by FCS Comparison>

The following describes loop reception detection by FCS comparison with reference to FIGS. 12 and 13. FIG. 12 is a diagram illustrating part of a frame forwarding path. In the communication network 1-2, a path 41 indicates part of the frame forwarding path when no loop forwarding occurs, on which a frame flows through the router bridges RB6, RB8, and RB10 in this order.

A path 42 indicates part of the frame forwarding path when loop forwarding occurs, on which a frame flows in a loop through the router bridges RB8, RB10, RB12, RB9, and RB8 in this order.

FIG. 13 is a diagram for description of operation of detecting loop reception by performing FCS comparison.

(State St1) State St1 illustrates frames f14 and f15 generated at the router bridges RB6 and RB8 on the path 41.

The router bridge RB6 sets B to the hop count value of the frame f14 and calculates the FCS thereof to be 0xBBBBBBBB, thereby generating the frame f14 including the hop count value=B and the FCS=0xBBBBBBBB.

The router bridge RB8 sets X to the hop count value of the frame f15 and calculates the FCS thereof to be 0xXXXXXXXX thereby generating the frame f15 including the hop count value=X and the FCS=0xXXXXXXXX. The operation of generating the header parts of the frames f14 and f15 is described above with reference to FIG. 10, and thus any duplicate description will be omitted.

(State St2) State St2 illustrates frames f14a and f15 generated at the router bridges RB9 and RB8 on the path 42.

The router bridge RB9 sets A to the hop count value of the frame f14a and calculates the FCS thereof to be 0xAAAAAAAA, thereby generating the frame f14a including the hop count value=A and the FCS=0xAAAAAAAA.

As for the header part of the frame f14a, the MAC address “A” is set to the inner MAC SA, and the MAC address “B” is set to the inner MAC DA, in the inner MAC header of the frame f14a. In the TRILL header, the identifier “RB1” of the router bridge RB1 is set to the ingress RB nickname, and the identifier “RB11” of the router bridge RB11 is set to the egress RB nickname.

In addition, the MAC address “L” of the router bridge RB9 is set to the outer MAC SA, and the MAC address “K” of the router bridge RB8 is set to the outer MAC DA, in the outer MAC header.

The router bridge RB8 sets X to the hop count value of the frame f15 and calculates the FCS to be 0xXXXXXXXX, thereby generating the frame f15 including the hop count value=X and the FCS=0xXXXXXXXX

Consider a case in which, after transmitted from the router bridge RB8, the frame f15, the hop count value of which is rewritten, is forwarded in a loop through the path 42 and returned to the router bridge RB8 again.

In this case, contents from the outer MAC header to the payload remain the same, and thus the FCS remains the same, too. Accordingly, when the FCS of the received frame is found to match with a FCS registered in the FCS table T3 through comparison, the router bridge RB8 determines that the output frame is returned, and discards the frame.

As described above, when having received a frame including a hop count value of zero, each router bridge RB rewrites the hop count value so that the frame reaches a destination terminal.

However, when only the hop count value of a forwarded frame is rewritten, the frame is potentially forwarded in a loop on a TRILL network.

To avoid this, a router bridge RB that rewrites the hop count value calculates a FCS and stores the calculated FCS in the FCS table. Then, the router bridge RB compares the FCS of a received frame with the FCS stored in the FCS table. When the FCSs match with each other, the router bridge RB determines that the frame is received in a loop, and discards the frame.

Accordingly, the router bridge RB allows the frame to be forwarded to a destination terminal without limitation by the hop count value and avoids occurrence of the loop reception, which leads to high efficiency and scalability of frame forwarding.

<Flowchart>

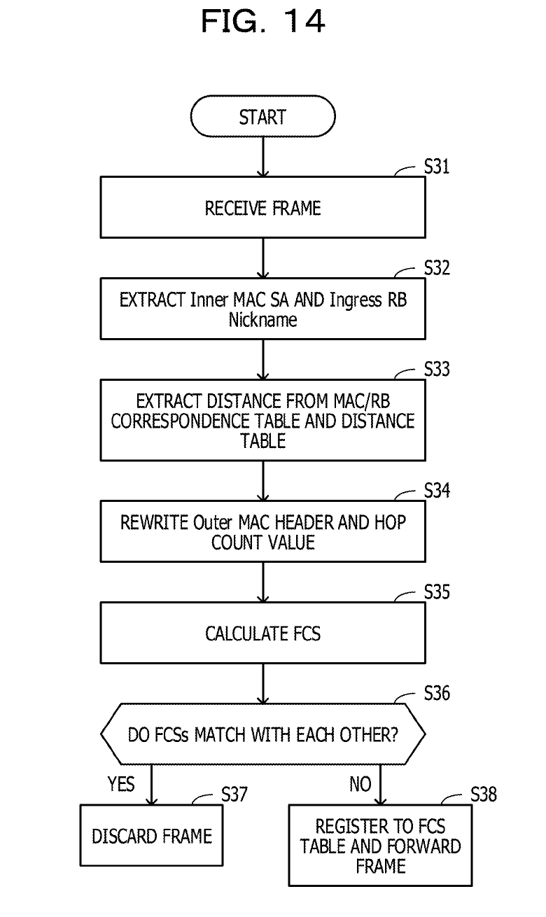

FIG. 14 is a flowchart illustrating operation of a router bridge.

[Step S31] This router bridge RB receives a frame.

[Step S32] The router bridge RB extracts the inner MAC SA and the ingress RB nickname from the received frame.

[Step S33] The router bridge RB extracts the distance to a router bridge RB belonging to a destination terminal from the MAC/RB correspondence table T1 and the distance table T2.

[Step S34] The router bridge RB rewrites the outer MAC header of the received frame, and rewrites the hop count value based on the distance when the received frame has a hop count value of zero.

[Step S35] The router bridge RB calculates the FCS of the frame after the hop count value rewriting.

[Step S36] The router bridge RB compares the FCS of the received frame with a FCS registered to the FCS table T3. The process proceeds to step S37 when the FCSs match with each other, or proceeds to step S38 when the FCSs do not match with each other.

[Step S37] The router bridge RB determines loop reception and discards the received frame.

[Step S38] The router bridge RB registers the calculated FCS to the FCS table T3 and forwards the frame.

The above-described processing functions of the forwarding control device 1 and each router bridge RB according to the present disclosure may be each achieved by a computer. In this case, a computer program that describes processing contents of the functions achieved by the forwarding control device 1 and the router bridge RB is provided. The computer program is executed by a computer to achieve the above-described processing functions on the computer.

The computer program describing the processing contents may be recorded in a computer-readable recording medium. Examples of the computer-readable recording medium include a magnetic storage device, an optical disk, a magneto-optical recording medium, and a semiconductor memory. Examples of the magnetic storage device include a hard disk device (HDD), a flexible disk (FD), and a magnetic tape. Examples of the optical disk include a DVD, a DVD-RAM, and a CD-ROM/RW. Examples of the magneto-optical recording medium include a magneto-optical disk (MO).

When the computer program is distributed, for example, a portable recording medium, such as a DVD or a CD-ROM, on which the computer program is recorded is sold. The computer program may be stored in a storage device of a server computer and transferred from the server computer to another computer through a network.

A computer that executes the computer program stores, in a storage device of the computer, the computer program recorded in a portable recording medium or transferred from the server computer, for example. Then, the computer reads the computer program from the storage device and executes processing in accordance with the computer program. Alternatively, the computer may read the computer program directly from the portable recording medium, and execute processing in accordance with the computer program.

Alternatively, each time the computer program is transferred from the server computer coupled with the computer through a network, the computer may sequentially execute processing in accordance with the received computer program. At least part of the above-described processing functions may be achieved by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A first relay device included in a plurality of relay devices each of which configured to forward a frame to another relay device, the first relay device comprising:
a memory; and
a processor coupled to the memory and configured to:
receive a frame which includes a count value which is reduced by another relay device according to forwarding by the another relay device;
set a second value in the count value of the received frame, wherein the second value is specified in accordance to a destination device of the frame, and
after setting the second value in the count value, transmit the frame to another relay device of the plurality of relay devices.

2. The first relay device according to claim 1, wherein
a processor is configured to, when the count value included in the received frame is equal to a third value, set the second value in the count value of the frame.

3. The first relay device according to claim 2, wherein
when the first relay device is coupled with the destination device through no other relay device of the plurality of relay devices, the processor is configured to transmit the frame to the destination device without setting the second value in the count value.

4. The first relay device according to claim 3, wherein
the processor is configured to discard the frame when receiving the frame again after transmitting the frame of which the second value is set in the count value to the another relay device.

5. The first relay device according to claim 4, wherein
in a case that a second relay device of the plurality of relay devices is directly coupled with the destination device, the processor is configured to set the second value equal to the third value when the frame reaches the second relay device.

6. The first relay device according to claim 5, wherein:
the first value is 1,
the third value is 0, and
the second value is a value obtained by subtracting 1 from the number of hops from the first relay device to the second relay device.

7. The first relay device according to claim 2, wherein
the processor is configured to detect a correspondence relation between the destination device and the first relay device based on source address information included in another frame output from the destination device and identification information of the first relay device.

8. The first relay device according to claim 4, wherein
the processor is configured to:
specify first error detection data of the frame when transmitting the frame to the another relay device;
when receiving the frame again after the transmission of the frame, specify second error detection data of the frame received again;
detect that the first error detection data matches with the second error detection data; and
discard the frame.

9. The first relay device according to claim 2, wherein the frame is a Transparent Interconnection of Lots of Links (TRILL) frame.

10. A method using a first relay device included in a plurality of relay devices each of which configured to forward a frame, the method comprising:
receiving a frame which includes a count value which is reduced by another relay device according to forwarding by the another relay device;
setting a second value in the count value of the received frame, wherein the second value is specified in accordance to a destination device of the frame; and
after setting the second value in the count value, transmitting the frame to another relay device of the plurality of relay devices.

11. The method according to claim 10, wherein
when the count value included in the received frame is equal to a third value, the second value is set in the count value of the received frame.

12. The method according to claim 11, the method further comprising:
when the first relay device is coupled with the destination device through no other relay device of the plurality of relay devices, transmitting the frame to the destination device without setting the second value in the count value.

13. The method according to claim 12, the method further comprising:
discarding the frame when receiving the frame again after transmitting the frame of which the second value is set in the count value to the another relay device.

14. The method according to claim 13, the method further comprising:
in a case that a second relay device of the plurality of relay devices is directly coupled with the destination device, setting the second value equal to the third value when the frame reaches the second relay device.

15. The method according to claim 14, wherein:
the first value is 1,
the third value is 0, and
the second value is a value obtained by subtracting 1 from the number of hops from the first relay device to the second relay device.

16. The method according to claim 11, the method further comprising:
detecting a correspondence relation between the destination device and the first relay device based on source address information included in another frame output from the destination device and identification information of the first relay device.

17. A non-transitory computer-readable storage medium storing a program that causes a first relay device to execute a process, the first relay device being included in a plurality of relay devices each of which configured to forward a frame, the process comprising:
receiving a frame which includes a count value which is reduced by another relay device according to forwarding by the another relay device;
setting a second value in the count value of the received frame, wherein the second value is specified in accordance to a destination device of the frame; and
after setting the second value in the count value, transmitting the frame to another relay device of the plurality of relay devices.

18. The non-transitory computer-readable storage medium according to claim 17, wherein
when the count value included in the received frame is equal to a third value, the second value is set in the count value of the received frame.

19. The non-transitory computer-readable storage medium according to claim 18, the process further comprising:
when the first relay device is coupled with the destination device through no other relay device of the plurality of relay devices, transmitting the frame to the destination device without setting the second value in the count value.

20. The non-transitory computer-readable storage medium according to claim 19, the process further comprising:
discarding the frame when receiving the frame again after transmitting the frame of which the second value is set in the count value to the another relay device.
